(19) United States
(12) Patent Application Publication
(10) Pub. No.: US 2026/0296858 A1
(43) Pub. Date: Oct. 1, 2026

(54) ALL-WHEEL DRIVE TRANSMISSION FOR AN ELECTRIC FORKLIFT

(71) Applicant: Oshkosh Corporation, Oshkosh, WI (US)

(72) Inventors: Arnau Barba Martinez, Manresa (ES); Ramón Cano Prieto, Manresa (ES); Albert Hidalgo Torres, Manresa (ES); Manel Tirado Galbany, Manresa (ES)

(73) Assignee: Oshkosh Corporation, Oshkosh, WI (US)

(21) Appl. No.: 19/633,821

(22) Filed: Mar. 30, 2026

Related U.S. Application Data
(60) Provisional application No. 63/781,099, filed on Mar. 31, 2025.

(51) Int. Cl. B66F 9/075

(52) U.S. Cl. CPC B66F 9/07572; B66F 9/0755

(57) ABSTRACT

A forklift includes a chassis including a first axle positioned on a first side of the chassis and a second axle positioned on a second side of the chassis. The first side of the chassis is coupled to a fork assembly and the second side of the chassis is disposed opposite the first side of the chassis. The vehicle further includes a first transmission system coupled to and configured to rotate the first axle. The vehicle further includes a second transmission system coupled to and configured to rotate the second axle. The vehicle further includes a gear transfer box coupled to the second axle. The gear transfer box includes a torque amplification stage configured to increase a torque of the first axle. The second axle is configured to turn about an axial axis perpendicular to a longitudinal axis to steer the forklift.

### CROSS REFERENCE TO RELATED APPLICATION

This application claims the benefit of and priority to U.S. Provisional Patent Application No.: 63/781,099, filed on Mar. 31, 2025, the entire disclosure of which is hereby incorporated by reference herein.

### BACKGROUND

The present disclosure relates to forklifts. More particularly, the present disclosure relates to forklifts equipped with a modular drivetrain that includes electric axles and selective torque distribution features.

### SUMMARY

In some embodiments, the techniques described herein relate to a forklift. The forklift includes a chassis including a first axle positioned on a first side of the chassis and a second axle positioned on a second side of the chassis. The first side of the chassis is coupled to a fork assembly and the second side of the chassis is disposed opposite the first side of the chassis. The forklift further includes a first transmission system coupled to and configured to rotate the first axle. The forklift further includes a second transmission system coupled to and configured to rotate the second axle. The vehicle further includes a gear transfer box coupled to the second axle. The gear transfer box includes a torque amplification stage configured to increase a torque of the first axle. The second axle is configured to turn about an axial axis perpendicular to a longitudinal axis to steer the forklift.

In some embodiments, the techniques described herein relate to a forklift. The forklift includes a chassis. The forklift further includes a first axle positioned on a first side of the chassis; a second axle positioned on a second side of the chassis. The forklift further includes a fork assembly on the first side of the chassis. The forklift further includes a first transmission system coupled to and configured to rotate the first axle. The forklift further includes a second transmission system coupled to and configured to rotate the second axle. The forklift further includes a gear transfer box coupled to the second axle. The gear transfer box includes a torque amplification stage configured to increase a torque of the first axle. The forklift further includes a controller including at least one processor or memory configured to electronically communicate with the gear transfer box to raise or lower a torque of the first axle or the second axle based on one or more vehicle parameters.

In some embodiments, the techniques described herein relate to a method. The method includes rotating, by an electric motor, a first axle and a second axle of a vehicle. The method further includes sensing, by one or more sensors disposed on the vehicle, a characteristic. The characteristic can include a connection or disconnection status of the first axle or the second axle, a mechanical limit of a first transmission system coupled to the first axle or a second transmission system coupled to the second axle, or a resistance provided to the vehicle by surrounding terrain. The method further includes adjusting, by a gear transfer box, a torque applied to the first axle or the second axle based on the characteristic. The method further includes lifting, by a fork system disposed adjacent to the first axle, an object.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is side view of a forklift including a drivetrain, according to an exemplary embodiment;

FIG. 2 is a schematic diagram of the drivetrain of the forklift of FIG. 1, according to an exemplary embodiment;

FIG. 3 is a schematic diagram of an alternate drivetrain layout of the forklift of FIG. 1, according to an exemplary embodiment;

FIG. 4 is a cross-sectional view of the drivetrain of the forklift of FIG. 1, according to an exemplary embodiment;

FIG. 5 is a perspective view of the drivetrain of the forklift of FIG. 1, according to an exemplary embodiment;

FIG. 6 is a bottom view of the forklift of FIG. 1, according to an exemplary embodiment;

FIG. 7 is a schematic diagram of an alternate drivetrain layout of the forklift of FIG. 1, according to another exemplary embodiment;

FIG. 8 is a schematic diagram of an alternate drivetrain layout of the forklift of FIG. 1, according to another exemplary embodiment;

FIG. 9 is a block diagram of a control system for the electric drivetrain of FIG. 2, according to an exemplary embodiment;

FIG. 10 is a flow diagram of a process for transitioning a forklift from rear-wheel drive to all-wheel drive based on sensed torque demand or traction loss, according to an exemplary embodiment; and

FIG. 11 is a flow diagram of a method of operating a vehicle, according to an exemplary embodiment.

### DETAILED DESCRIPTION

Before turning to the FIGURES, which illustrate the exemplary embodiments in detail, it should be understood that the present application is not limited to the details or methodology set forth in the description or illustrated in the FIGURES. It should also be understood that the terminology is for the purpose of description only and should not be regarded as limiting.

### Overview

Referring generally to the FIGURES, systems and methods for dynamically controlling drive mode operation of a forklift are shown. In some embodiments, the forklift includes front and rear electric axles, where at least one axle includes an electric motor configured to generate mechanical torque to drive a corresponding pair of ground-engaging wheels. Traditionally, forklifts are configured in fixed two-wheel drive arrangements. However, maintaining continuous engagement of all axles can increase energy consumption and accelerate tire wear. Advantageously, drivetrain architectures described herein enable selective engagement of a rear axle to transition from a rear-wheel drive mode to an all-wheel drive (AWD) mode based on operating conditions. This enables efficient power delivery and improved traction while reducing mechanical complexity and operational cost.

The present disclosure relates to forklifts and material handling configured to provide enhanced traction, torque control, and operational flexibility. The forklifts can operate in both two-wheel drive and four-wheel drive configurations, and can include a selectively engageable rear axle disconnection system, which can include a clutch assembly, differential disengagement, or other mechanisms.

Forklifts can be limited to two-wheel drive operation, which can reduce mobility on uneven terrain and increase tire and transmission wear when high torque is applied. The forklift described herein can include an electronically controlled all-wheel drive (AWD) system that allows selective engagement of a rear drive axle to enhance traction. A dynamic motor torque control system adjusts torque delivery based on terrain or loading conditions, allowing seamless transition between traction configurations. The result is improved efficiency, battery life, and maneuverability, particularly when operating on rough or changing surfaces.

### All-Wheel Drive Electric Forklift

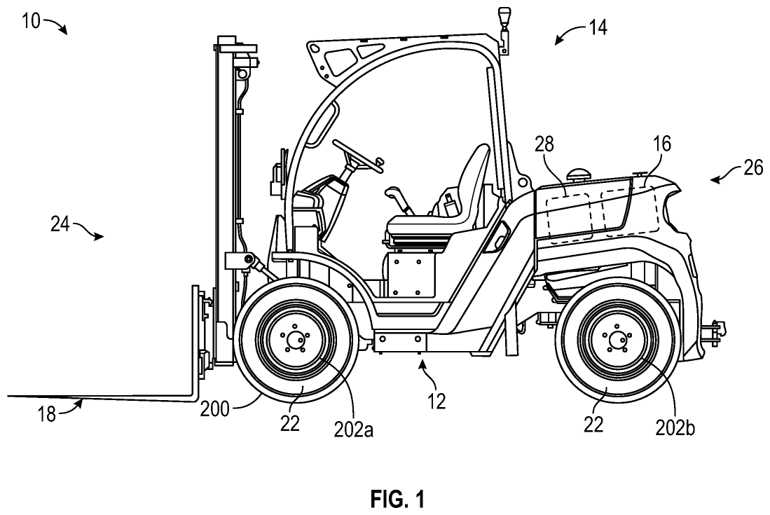

According to the exemplary embodiment shown in FIG. 1, a vehicle (a forklift, an electric forklift, a telehandler, a material handling vehicle, etc.), shown as forklift 10, includes a lifting apparatus, shown as fork assembly 18. In some embodiments, the forklift 10 is configured as a telehandler. In some embodiments, the forklift 10 is configured as an electric forklift 10. In other embodiments, forklift 10 is configured as a counterbalance forklift, a rough terrain forklift, or any other type of lift truck used for handling pallets or loads in commercial or industrial environments.

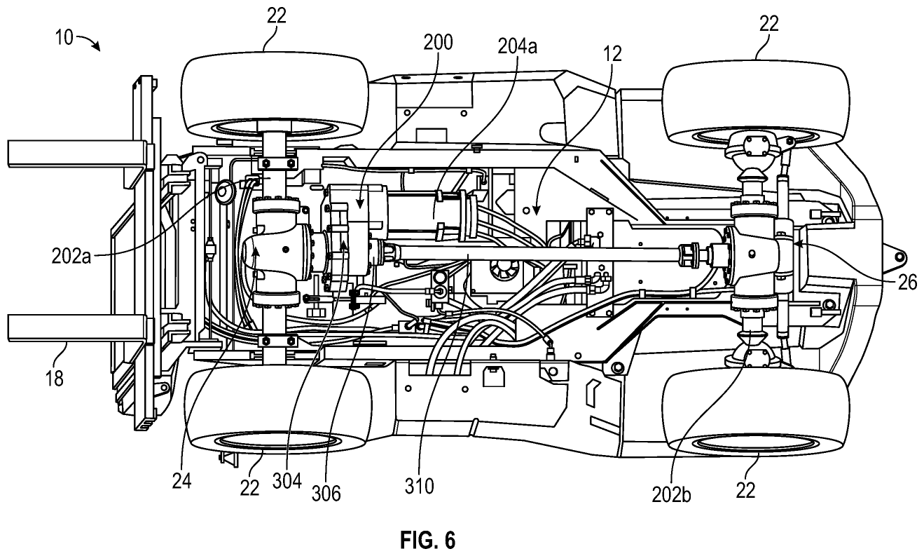

As shown in FIGS. 1 and 6, the forklift 10 includes a chassis (e.g., a frame member, a support member, a structural member, etc.), shown as frame 12, and a cab, shown as cab 14, coupled to the frame 12 (e.g., at a front end thereof, etc.). The cab 14 may include various components to facilitate operation of the forklift 10 by an operator (e.g., a seat, a steering wheel, an overhead guard, hydraulic controls, a user interface, switches, buttons, dials, etc.).

In some embodiments, forklift 10 includes one or more sensors configured to detect operational or environmental conditions. The sensors can be mounted on or within frame 12, cab 14, drivetrain 200, or other components of forklift 10. The sensors may include wheel speed sensors configured to detect individual wheel rotation rates, inclination sensors (e.g., gyroscopes, tilt sensors) configured to determine forklift pitch or roll angles, and/or motor torque sensors configured to measure torque demand or output from engine 16 or another electric motor of forklift 10.

As shown in FIG. 1, the forklift 10 includes a prime mover, shown as engine 16, according to an exemplary embodiment. In some embodiments, engine 16 is an electric motor configured to be powered by an electrical energy source. In some embodiments, engine 16 is disposed in compartment at a rear side 26 of forklift 10 and is operably coupled to frame 12. The engine 16 may be configured to utilize one or more of a variety of fuels (e.g., gasoline, diesel, bio-diesel, ethanol, natural gas, etc.), according to various exemplary embodiments. According to an alternative embodiment, the prime mover additionally or alternatively includes one or more electric motors and/or generators, which may be coupled to the frame 12 (e.g., a hybrid vehicle, an electric vehicle, etc.). The electric motors may consume electrical power from an on-board storage device (e.g., batteries, ultra-capacitors, etc.), from an on-board generator (e.g., an internal combustion engine, a genset, etc.), and/or from an external power source (e.g., overhead power lines, etc.) and provide power to systems of the forklift 10. In some embodiments, the forklift 10 does not include the engine 16 (e.g., the engine 16 is optional). In some embodiments, the engine 16 is an electric motor. In some embodiments, the prime mover is a hybrid system including an internal combustion engine and one or more electric motors. In some embodiments, forklift 10 does not include an internal combustion engine. The electric motor or motors are configured to receive energy from an energy source (e.g., electrical energy storage device 28, an external power supply, etc.) and convert the energy into mechanical power for propulsion and system operation.

In some embodiments, sensors of the forklift 10 can include one or more geolocation sensors (e.g., GPS modules) configured to determine a position or route of forklift 10. The sensors of the forklift 10 can include one or more environmental sensors such as radar or LiDAR sensors configured to detect terrain features, surface conditions, and/or obstacles. The sensor data may be used to infer load weight, detect inclines, and/or identify high-friction or low-friction ground conditions.

Referring to FIGS. 1 and 6, the forklift 10 includes a lifting apparatus, shown as fork assembly 18. Fork assembly 18 includes one or more lift forks configured to support and transport a load (e.g., pallet, container, bulk material, etc.). In some embodiments, fork assembly 18 includes a first lift fork and a second lift fork that are laterally spaced from one another. In some embodiments, the first lift fork and the second lift fork are movable relative to one another to adjust a separation distance between the lift forks. Fork assembly 18 can include one or more fork separation sensors configured to detect the separation between the first lift fork and the second lift fork. The fork separation sensor may be or include an ultrasonic sensor, a laser distance sensor, a photoelectric sensor, or another proximity sensor configured to detect or measure a distance between adjacent forks. In some embodiments, fork assembly 18 includes a single fork separation sensor configured to detect the spacing between a pair of lift forks. In other embodiments, when fork assembly 18 includes three or more lift forks, multiple fork separation sensors may be included to detect separations between adjacent pairs of lift forks.

As shown in FIG. 1, the forklift 10 includes a plurality of tractive elements, shown as wheels 22, that engage a ground surface to move the forklift 10. In one embodiment, at least a portion of the mechanical power produced by the engine 16 flows through a transmission to power at least a portion of the wheels 22 (e.g., front wheels, rear wheels, etc.). In one embodiment, energy (e.g., mechanical energy, etc.) flows along a first power path defined from the engine 16, through the transmission, and to the wheels 22.

Referring still to FIGS. 1 and 6, forklift 10 includes a drivetrain 200 (e.g., a chassis assembly, a frame assembly, etc.). Drivetrain 200 includes a front axle 202a and a rear axle 202b. In some embodiments, the front axle 202a and the rear axle 202b are rotatably coupled with corresponding pairs of wheels 22.

Rear axle 202b can be a steerable axle and can be selectively powered through torque transfer from a front-mounted electric motor via a gear transfer box, clutch, and torque transfer shaft, or through an independent secondary electric motor. In some embodiments, rear axle 202b is selectively engageable via a disconnection mechanism that can include a wet disc clutch, a central differential, or another electronically controlled torque modulation device. When forklift 10 operates in a two-wheel drive mode, mechanical power is transmitted to front axle 202a only, while rear axle 202b remains disconnected to improve energy efficiency and reduce tire wear. When operating in a four-wheel drive mode, torque can be delivered to both front axle 202a and rear axle 202b for enhanced traction on rough, sloped, or slippery terrain. The ability to switch between two-wheel and four-wheel drive configurations enables dynamic adaptation to terrain and loading conditions, which can improve maneuverability, drive stability, and drivetrain longevity.

The forklift 10 can include an electrical energy storage device 28 (e.g., a battery, a capacitor, etc.) that is configured to store electrical energy for one or more of the axles 202a and/or 202b, or for one or more of the electric motors of the axles 202a and/or 202b. In some embodiments, the one or more axles 202a and/or 202b are configured to consume electrical energy from the electrical energy storage device 28 to drive forklift 10 and/or to drive an accessory of forklift 10.

### Drivetrain Configuration

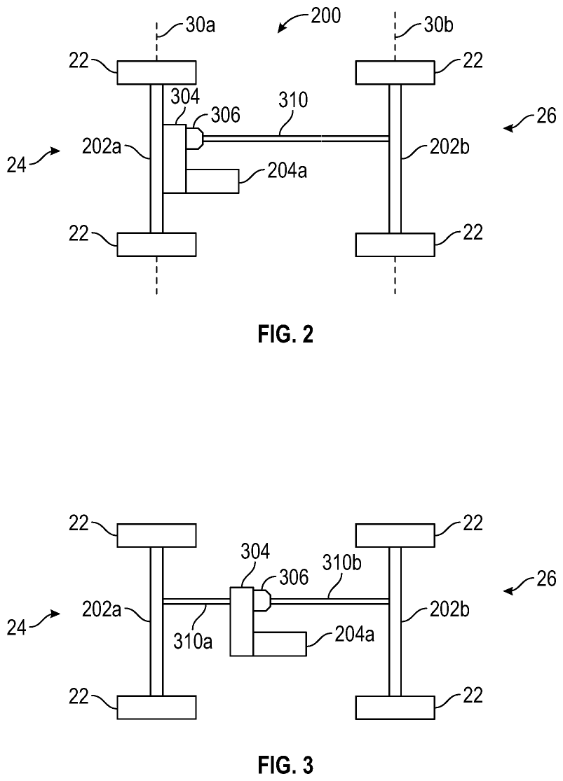

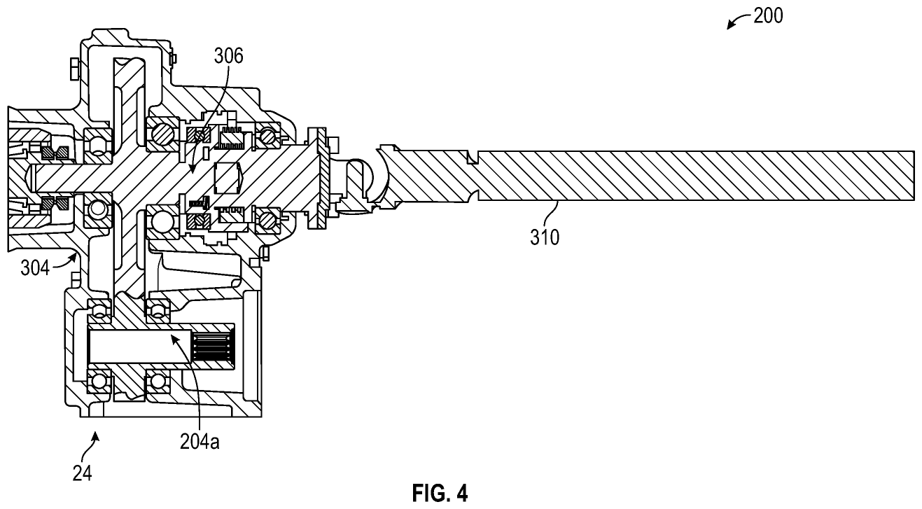

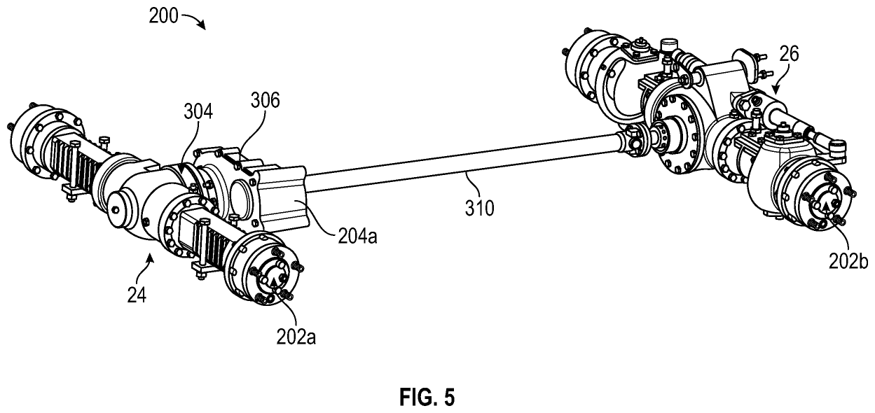

Referring to FIGS. 2 and 4-6, drivetrain 200 is shown, according to an exemplary embodiment. Drivetrain 200 includes a front axle 202a positioned at a front side 24 of the chassis of forklift 10, and a rear axle 202b positioned at a rear side 26 of forklift 10. As shown in FIGS. 2 and 5-6, the front side 24 is disposed on an opposite of the chassis from the rear side 26. In some embodiments, rear axle 202b can be a steering axle, thereby facilitating maneuverability during forklift operation. For example, the second axle 202b can be configured to turn about an axial axis perpendicular to the longitudinal axis 30b of the second axle 202b to steer the vehicle. The drivetrain 200 can further include an electric motor 204a, a gear transfer box 304, a disconnection system (e.g., a clutch 306), and a shaft 310 (e.g., torque transfer shaft 310). In some embodiments, drivetrain 200 is configured to operate in an all-wheel drive (AWD) mode, in which both front axle 202a and rear axle 202b are powered simultaneously. In some embodiments, drivetrain 200 is configured to operate in a two-wheel drive (2WD) mode (e.g., rear-wheel drive mode), in which only front axle 202a receives torque and rear axle 202b is disconnected via clutch 306.

In some embodiments, front axle 202a and rear axle 202b are each rotatably coupled to a respective pair of ground-engaging tractive elements. For example, front axle 202a and rear axle 202b are each rotatably coupled with a pair of wheels 22. Each pair of wheels 22 rotates about a corresponding axle-defined rotational axis. For example, the front axle 202a may define axis 30a about which the wheels 22 of front axle 202a rotate, and the rear axle 202b may define axis 30b about which the wheels 22 of rear axle 202b rotate. In some embodiments, front axle 202a functions as the primary drive axle, and rear axle 202b functions as a selectively engageable auxiliary drive axle.

As shown in FIGS. 2 and 4-6, and in some embodiments, electric motor 204a can be operably coupled to the front axle 202a via gear transfer box 304. Electric motor 204a is configured to receive electrical energy from an electrical energy storage device 28 (e.g., battery) and output mechanical torque to the gear transfer box 304. Gear transfer box 304 can include a torque amplification stage (e.g., a reduction gearset) that increases output torque from motor 204a before delivery to front axle 202a or to downstream components. In some embodiments, torque distribution between axles is controlled by at least one of a clutch mechanism, a central differential housed within gear transfer box 304, and an electronic traction management system configured to evaluate operating conditions and modulate axle engagement accordingly.

In some embodiments, torque distribution between front axle 202a and rear axle 202b is governed by one or more torque control mechanisms. The torque control mechanisms can include a clutch mechanism, a central differential, and/or an electronic traction management system. The clutch mechanism (e.g., clutch 306) is operably positioned between gear transfer box 304 and shaft 310, and is configured to selectively engage or disengage torque transmission to rear axle 202b. When clutch 306 is in an engaged state, drivetrain 200 operates in an all-wheel drive (AWD) mode; when clutch 306 is in a disengaged state, rear axle 202b is decoupled, and the vehicle operates in a front-drive mode. In some embodiments, gear transfer box 304 includes a central differential configured to balance rotational speed differences between front axle 202a and rear axle 202b during AWD operation. The central differential enables both axles to rotate at different speeds while maintaining torque delivery, such as during turning maneuvers or operation over uneven terrain. In further embodiments, drivetrain 200 includes an electronic traction management system configured to evaluate operating conditions and modulate engagement of the clutch mechanism or differential to enhance traction and drivability.

In some embodiments, the front axle 202a may be an electric axle, and may include an electric motor 204a that is configured to consume electrical energy from the electrical energy storage device 28 and generate mechanical power using the electrical energy. In some embodiments, front axle 202a does not include electric motor 204a and wheels 22 rotate about axis 30a in response to transportation of forklift 10 (e.g., due to engagement between wheels 22 and a ground surface).

Gear transfer box 304 can be or include a reduction gearbox (e.g., a gearset that receives input mechanical energy at a first speed and outputs mechanical energy at a second, lower, speed) or may be or include a gearbox that receives input mechanical energy at a first speed and outputs mechanical energy at a second, higher, speed. In some embodiments, gear transfer box 304 can be or include a differential that is configured to receive rotational kinetic energy or mechanical energy from electric motor 204a and output rotational kinetic energy or mechanical energy along multiple output paths, including through front axle 202a and/or through shaft 310 to rear axle 202b. The gear transfer box 304 can convert rotational input about a first axis into one or more outputs about axes 30a and 30b, which may extend in different directions. In some embodiments, gear transfer box 304 is configured to distribute torque between front axle 202a and rear axle 202b via shaft 310. Gear transfer box 304 may include internal gearing, such as planetary or bevel gears, and in some embodiments further incorporates a central differential configured to balance rotational speeds between front axle 202a and rear axle 202b during AWD operation. In some embodiments, gear transfer box 304 includes dual output ports: a first output port coupled to front axle 202a and a second output port coupled to clutch 306 and shaft 310. In this configuration, gear transfer box 304 distributes torque between both axles during AWD operation.

In some embodiments, gear transfer box 304 is operably coupled to rear axle 202b through a driveline that includes clutch 306 and shaft 310. Shaft 310 can be or include a torque transfer shaft (e.g., a cardan shaft) configured to transmit mechanical torque to rear axle 202b. In some embodiments, shaft 310 can be or include a rotational torque transfer shaft (e.g., a cardan shaft, a propeller shaft, a universal jointed shaft, or a driveline shaft) configured to transmit rotational energy from gear transfer box 304 at front axle 202a to rear axle 202b. The shaft 310 may include one or more universal joints or flexible couplings to accommodate angular misalignment or articulation between front axle 202a and rear axle 202b (e. g, when forklift 10 operates over uneven terrain). In some embodiments, the shaft 310 is a rigid, torque-carrying shaft with splined or flanged ends configured to interface with clutch 306 and a differential assembly of rear axle 202b. In other embodiments, shaft 310 may include intermediate support bearings or telescopic sections to maintain alignment and accommodate chassis flexing during operation. In some embodiments, clutch 306 is integrated within gear transfer box 304 and functions as an AWD disconnection mechanism, enabling selective disengagement of rear axle 202b to transition from AWD mode to 2WD mode.

Clutch 306 can be positioned between gear transfer box 304 and shaft 310 and is operable to selectively engage or disengage rear axle 202b from the drivetrain to switch between AWD and 2WD modes. Clutch 306 is configured to transition between an engaged state and a disengaged state, such as in response to receiving a control signal. In the engaged state, clutch 306 transmits mechanical energy from gear transfer box 304 to shaft 310, enabling rear axle 202b to receive torque from motor 204a. In the disengaged state, clutch 306 isolates rear axle 202b, allowing forklift 10 to operate in a two-wheel drive mode using only front axle 202a.

In some embodiments, clutch 306 is or includes an electronically controlled wet disc clutch, a multi-plate clutch, or another torque coupling device. Clutch 306 may further enable controlled slip, soft engagement (e.g., progressive torque engagement), or dynamic torque distribution when transitioning between two-wheel and four-wheel drive configurations. A control system (e.g., electronic controller) can manage clutch engagement in real-time based on inputs including terrain type, traction loss, speed, or operator commands. Clutch 306 may be actuated manually by operator input or automatically in response to real-time control signals generated by a control system based on sensor data (e.g., wheel speed, terrain gradient, motor torque, etc.). In some embodiments, drivetrain 200 further includes an electronic traction management system configured to selectively engage or disengage rear axle 202b via clutch 306 or a central differential based on detected load, terrain conditions, or operator commands.

Referring now to FIG. 3, an alternate drivetrain configuration is shown, according to an exemplary embodiment. FIG. 3 illustrates a drivetrain layout in which electric motor 204a is mounted adjacent to rear axle 202b and directly delivers torque to the rear axle. A gear transfer box 304 is operably coupled between motor 204a and rear axle 202b to amplify torque prior to delivery. A shaft 310 (e.g., a cardan shaft or driveline shaft) extends forward from the gear transfer box 304 and is configured to selectively deliver torque to front axle 202a. A disconnection system (e.g., a clutch 306) is positioned along shaft 310 and configured to selectively engage or disengage torque transmission to the front axle 202a. Rear axle 202b can serve as the primary drive axle, while front axle 202a is a selectively engageable auxiliary axle. Drivetrain 200 is thereby configured to operate in a two-wheel drive mode in which torque is delivered to rear axle 202b alone, or in AWD mode in which torque is simultaneously delivered to both front axle 202a and rear axle 202b.

In such configuration, forklift 10 can operate in a rear-wheel drive mode under normal traction conditions, and the drivetrain 200 can transition to AWD mode when enhanced traction is needed (e.g., on uneven, inclined, or low-friction terrain). The disconnection system enables selective engagement of front axle 202a, thereby reducing energy consumption and tire wear when four-wheel drive is not required. Shaft 310 may include one or more universal joints or flexible couplings to accommodate vertical and angular offset between front axle 202a and rear axle 202b during AWD operation.

In some embodiments, clutch 306 is electronically controlled and receives control signals from an onboard controller. The controller may be configured to actuate clutch 306 in response to sensor inputs, such as wheel speed sensors, torque sensors, inclination sensors, or geolocation data. In some embodiments, drivetrain 200 further includes a central differential for torque balancing and an electronic traction management module configured to coordinate clutch actuation with vehicle dynamics. Based on these sensor inputs, clutch 306 may be engaged to transition from rear-wheel drive to AWD when torque demand or terrain conditions warrant. In this way, FIG. 3 illustrates a drivetrain configuration optimized for rear-drive priority with optional torque routing to the front axle through a modular shaft-based connection.

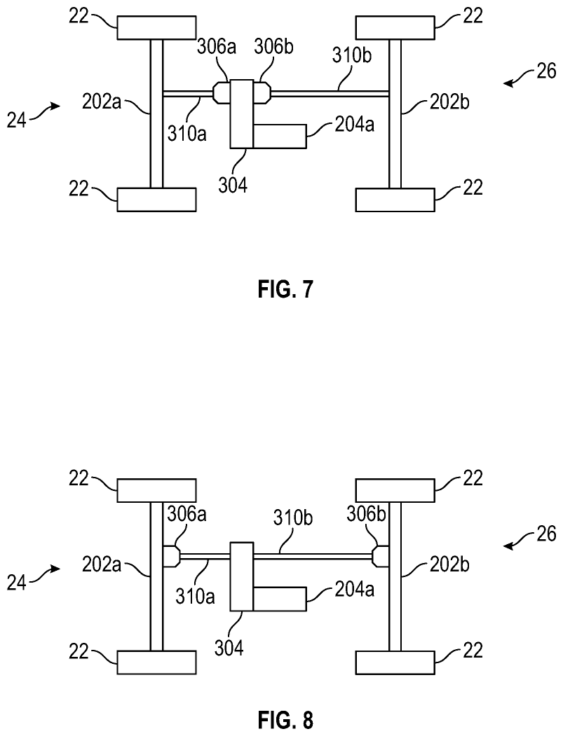

Referring now to FIG. 7, another exemplary drivetrain configuration is shown. In this embodiment, electric motor 204a is centrally mounted and operably coupled to a gear transfer box 304. Gear transfer box 304 is configured to receive mechanical energy output from electric motor 204a and distribute torque bidirectionally to both front axle 202a and rear axle 202b via a pair of torque transfer shafts 310a and 310b. Each torque transfer shaft 310a, 310b is selectively engageable via a corresponding disconnection device, such as clutch 306a and clutch 306b. In some embodiments, drivetrain 200 may include a traction management controller configured to determine when to engage clutches 306a and 306b based on terrain sensor inputs and axle load conditions. A first transmission system can include the torque transfer shaft 310a extending between the clutch 306a and the front axle 202a. A second transmission system can include the torque transfer shaft 310b extending between the clutch 306b and the rear axle 202b. The torque transfer shafts 310a and 310b can be configured to amplify torque output from the electric motor 204a. In some embodiments, the first transmission system is coupled to and configured to rotate the front axle 202a and the second transmission system is coupled to and configured to rotate the rear axle 202b.

In such configuration, drivetrain 200 enables dynamic control over torque distribution between the front side 24 and rear side 26 of forklift 10. Clutches 306a and 306b can be configured to transition (e.g.,. independently transition or dependently transition) between engaged and disengaged states (e.g., in response to a control signals from an electronic control unit). In some embodiments, when clutch 306a is engaged and clutch 306b is disengaged, torque is transmitted exclusively to front axle 202a. In some embodiments, when, clutch 306b is engaged and clutch 306a is disengaged, rear axle 202b is the torque-receiving axle. When both clutches are engaged, torque is distributed to both front axle 202a and rear axle 202b, thereby enabling an AWD mode in which both axles are powered simultaneously for enhanced traction performance.

Referring now to FIG. 8, drivetrain 200 is shown according to another exemplary embodiment. Drivetrain 200 includes an electric motor 204a disposed centrally along a longitudinal axis of forklift 10. Electric motor 204a is configured to produce mechanical energy and is operably coupled to a gear transfer box 304. Gear transfer box 304 is configured to receive the mechanical energy from electric motor 204a and distribute the mechanical energy through two torque transfer paths extending in opposing directions. A first torque transfer shaft 310a extends from gear transfer box 304 toward front axle 202a, and a second torque transfer shaft 310b extends from gear transfer box 304 toward rear axle 202b. A first clutch 306a is operably coupled between first torque transfer shaft 310a and front axle 202a, and a second clutch 306b is operably coupled between second torque transfer shaft 310b and rear axle 202b. In some embodiments, a central differential located within gear transfer box 304 and an onboard electronic control unit collectively manage torque distribution across front and rear axles based on traction demand, enabling automated transition between drive configurations.

Clutch 306a and clutch 306b are each configured to selectively transmit mechanical energy from gear transfer box 304 to front axle 202a and rear axle 202b, respectively. In this configuration, drivetrain 200 enables axle-selective torque delivery by positioning clutches 306a and 306b downstream of gear transfer box 304. Because torque transmission through gear transfer box 304 and torque transfer shafts 310a and 310b is maintained during clutch transitions, drivetrain 200 can minimize torque interruptions, driveline shock, and vibration. Additionally, isolating each axle at the clutch interface reduces mechanical loading on upstream driveline components and enables smooth transitions between rear-wheel drive and AWD configurations.

An all-terrain electric forklift is configured to operate over uneven or sloped ground surfaces. The forklift includes a front drive axle and a rear drive axle, each operably coupled to gear reducers configured to increase output torque from an electric motor to enhance tractive performance. A rear axle disconnection system can be included, the rear axle disconnection system comprising a clutch mechanism (e.g., a wet disc clutch), a central differential, or another torque modulation device configured to selectively isolate the rear axle from the drivetrain. The disconnection system is operable to reduce drivetrain wear and improve maneuverability under normal load or high-traction conditions. An electronic control system can be further provided, the electronic control system being configured to regulate torque output of the electric motor based on one or more sensed operating parameters, including terrain conditions, axle engagement status, and torque demand, to support appropriate traction mode selection and improve long-term drivetrain efficiency.

In some embodiments, the electric forklift described herein is implemented as an all-terrain forklift equipped with two drive axles and a rear steering axle. Each drive axle is coupled to an independent transmission system and configured to receive torque through a gear transfer box that increases output torque from one or more electric motors. The gear transfer box is operable to enhance tractive force, particularly during operation over uneven or sloped terrain.

In some embodiments, the forklift further includes a disconnection system configured to selectively engage or disengage the rear drive axle. The disconnection system may include at least one of the following: (i) a clutch mechanism that enables mechanical isolation of the rear axle from the drivetrain, (ii) a central differential configured to balance relative rotational speeds between the axles without fully disconnecting either axle, and/or (iii) an electronic traction management system that adjusts torque allocation based on detected terrain or load conditions.

In certain embodiments, the forklift includes a dynamic motor torque control system configured to regulate torque delivery based on one or more real-time vehicle parameters, characteristics, and/or conditions. The vehicle parameters can include a connection status of one of the axles, a maximum torque of the transmission systems, a load on the vehicle, or a terrain surrounding the vehicle. Torque output from the electric motors may be adjusted in response to the axle connection status, mechanical limitations of the transmission system, and external variables such as load weight or surface resistance.

In some embodiments, the forklift includes an automatic traction management system implemented via an electronic control unit. The control unit is configured to monitor operating conditions using a plurality of sensors and to modify traction configuration accordingly. Sensor inputs can include wheel speed sensors, inclination sensors, motor torque sensors, geolocation sensors, and environmental sensors such as radar or LiDAR.

In further embodiments, the forklift includes a wear and efficiency monitoring system configured to monitor deformation of a tractive element coupled to the axles. For example, the monitoring system can be configured to monitor tire wear and drivetrain component usage. The control system may be further operable to recommend changes to driving configuration or mode of operation to improve machine durability, energy efficiency, and performance over time.

### Control System

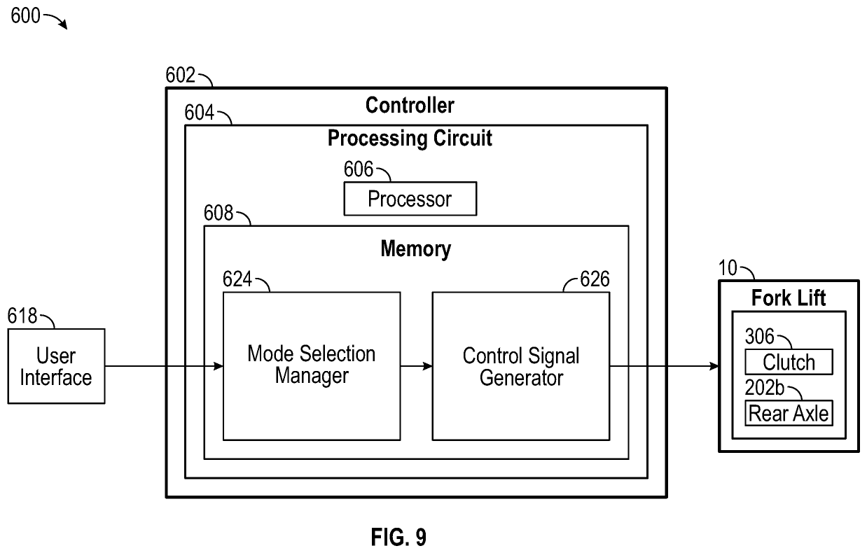

Referring particularly to FIG. 9, a control system 600 for operating drivetrain 200 of forklift 10 is shown, according to an exemplary embodiment. Control system 600 includes a controller 602, a user interface 618, and drivetrain components of forklift 10, including a rear axle 202b and a clutch 306. In some embodiments, clutch 306 is configured to selectively couple or decouple rear axle 202b from torque delivered by the drivetrain 200 (e.g., via shaft 310 and gear transfer box 304).

Controller 602 includes a processing circuit 604 including a processor 606 and memory 608. Processing circuit 604 can be communicably connected with a communications interface of controller 602 such that processing circuit 604 and the various components thereof can send and receive data via the communications interface. Processor 606 can be implemented as a general purpose processor, an application specific integrated circuit (ASIC), one or more field programmable gate arrays (FPGAs), a group of processing components, or other suitable electronic processing components. The controller 602 can be configured to electronically communicate with the gear transfer box to raise or lower a torque of the first axle or the second axle based on one or more vehicle parameters. The one or more vehicle parameters can include a connection states of the first axle or the second axle, a maximum torque of the transmission systems, a load on the vehicle, and/or a terrain surrounding the vehicle.

Memory 608 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 608 can be or include volatile memory or non-volatile memory. Memory 608 can include database components, object code components, script components, or any other type of information structure for supporting the various activities and information structures described in the present application. According to some embodiments, memory 608 is communicably connected to processor 606 via processing circuit 604 and includes computer code for executing (e.g., by processing circuit 604 and/or processor 606) one or more processes described herein.

In some embodiments, controller 602 is implemented within a single computer (e.g., one server, one housing, etc.). In various other embodiments, controller 602 can be distributed across multiple servers or computers (e.g., that can exist in distributed locations).

Referring still to FIG. 9, memory 608 includes a mode selection manager 624, and a control signal generator 626. Mode selection manager 624 is configured to receive user inputs from user interface 618. The user inputs may include a selection between different drivetrain configurations, such as rear-wheel drive (2WD) mode or all-wheel drive (AWD) mode. In some embodiments, the user input may indicate whether rear axle 202b should be engaged or disengaged. For example, the user input may transition forklift 10 between a 2WD mode in which only front axle 202a is driven, and an AWD mode in which both front axle 202a and rear axle 202b receive torque.

In some embodiments, drivetrain 200 is configured to operate in a rear-wheel drive (RWD) mode under standard traction conditions, wherein electric motor 204a delivers torque to front axle 202a, and rear axle 202b is mechanically disconnected via clutch 306. A transition to an all-wheel drive (AWD) mode can occur when one or more triggering conditions are detected by onboard sensors.

For example, drivetrain 200 may switch from RWD to AWD when wheel slip is detected, when an increase in required torque is sensed (e.g., during uphill driving), or when terrain irregularities such as mud, snow, or inclines are identified. Sensor systems can include wheel speed sensors configured to detect differential wheel rotation, inclination sensors configured to detect slope gradients, torque sensors that measure output demand at motor 204a, and optional environmental sensors such as radar or LiDAR for terrain classification.

Upon detection of a condition warranting AWD, control system 600 generates a control signal to actuate clutch 306 into an engaged state. In the engaged state, gear transfer box 304 routes torque through shaft 310 to rear axle 202b, thereby enabling simultaneous drive of both front axle 202a and rear axle 202b. This transition enhances traction and stability while maintaining real-time responsiveness to operational conditions. Once the terrain stabilizes or torque demand subsides, control system 600 may disengage clutch 306 to return drivetrain 200 to RWD mode for improved efficiency and reduced tire wear.

Referring still to FIG. 9, controller 602 is configured to control torque distribution within drivetrain 200 by selectively engaging or disengaging rear axle 202b. Controller 602 includes a processing circuit 604 comprising processor 606 and memory 608. Memory 608 stores executable instructions and control logic modules including mode selection manager 624 and control signal generator 626. In some embodiments, controller 602 receives user inputs from user interface 618, which may include a manual mode selection input or a request to enable adaptive drivetrain control. In other embodiments, mode selection manager 624 autonomously evaluates operating conditions using sensor data and determines whether drivetrain 200 should operate in rear-wheel drive (RWD) mode or all-wheel drive (AWD) mode.

Mode selection manager 624 is configured to analyze signals from various sensors of forklift 10 (e.g., wheel speed sensors, torque sensors, inclination sensors, or terrain-classifying sensors). When the detected conditions indicate low traction, increased torque demand, or uneven terrain, mode selection manager 624 generates a request to transition drivetrain 200 into AWD mode. This request is provided to control signal generator 626, which generates a control signal to actuate clutch 306. In response, clutch 306 transitions into the engaged state, thereby coupling gear transfer box 304 to shaft 310 and delivering torque to rear axle 202b.

In some embodiments, clutch 306 is the sole mechanical device for enabling or disabling AWD operation. In other embodiments, drivetrain 200 may also include a central differential within gear transfer box 304 to balance torque distribution between front axle 202a and rear axle 202b. Clutch 306 may be an electronically actuated wet disc clutch or multi-plate clutch configured to operate under real-time feedback control.

Control signal generator 626 is responsible for outputting engagement or disengagement signals to clutch 306 based on the selected mode provided by mode selection manager 624. In the disengaged state, clutch 306 isolates rear axle 202b, allowing drivetrain 200 to operate in RWD mode for improved energy efficiency and reduced tire wear. In the engaged state, torque is routed to both front axle 202a and rear axle 202b, enabling AWD operation and improved traction over variable terrain. Control signal generator 626 may additionally coordinate torque ramp-up to minimize driveline shock during mode transitions.

In this way, the drivetrain 200 of forklift 10 can dynamically transition between RWD and AWD based on either operator input or sensed operating conditions, with controller 602 managing system behavior through cooperative operation of mode selection manager 624 and control signal generator 626. The architecture allows forklift 10 to maintain maneuverability, optimize traction, and improve drivetrain longevity without requiring constant operator intervention.

### Process

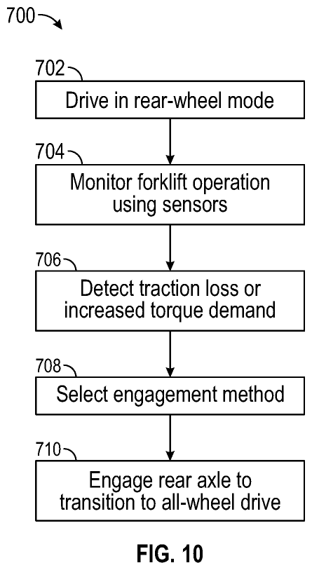

Referring generally to FIG. 10, depicted is a flow diagram for a drivetrain transition process 700 for selectively engaging all-wheel drive (AWD) in forklift 10 based on operational conditions, according to an exemplary embodiment. The process 700 may be implemented using any one or more of the components and devices detailed herein in conjunction with FIGS. 1-6. The steps described herein may be executed in the order shown, or in a different order, and independently or in combination with other steps. In some embodiments, one or more steps may be omitted from process 700, or additional steps may be included.

At step 702, forklift 10 operates in a default rear-wheel drive (RWD) mode. In this configuration, torque is delivered from electric motor 204a to front axle 202a, and rear axle 202b is disengaged via clutch 306. The drivetrain 200 remains in RWD mode to minimize energy consumption and reduce tire wear under low-load or high-traction conditions.

At step 704, forklift 10 is monitored using one or more onboard sensors. The sensors may include wheel speed sensors, motor torque sensors, inclination sensors, and terrain classification sensors. These sensors are configured to continuously detect performance indicators and external environmental conditions while forklift 10 is in motion.

At step 706, drivetrain controller 602 evaluates sensor input to determine whether a traction loss event or an increased torque demand is present. For example, detection of wheel slip, sudden acceleration input, a steep incline, or unstable terrain may trigger a reassessment of drive configuration requirements.

At step 708, based on the sensor evaluation, mode selection manager 624 determines a suitable engagement method to transition from rear-wheel drive to all-wheel drive operation. The engagement method can be selected according to multiple operational and environmental factors, including axle connection status, mechanical transmission limits, and real-time load or terrain conditions.

In some embodiments, the mode selection manager 624 determines that rear axle 202b should be coupled to the drivetrain by transitioning clutch 306 into an engaged state. In this configuration, the drivetrain 200 transitions from a two-wheel drive mode, in which torque is delivered to front axle 202a, to an all-wheel drive mode, in which torque is distributed to both front axle 202a and rear axle 202b.

In other embodiments, when drivetrain 200 includes a gear transfer box 304 with an integrated central differential, the mode selection manager 624 may initiate torque rebalancing by adjusting the relative output to front axle 202a and rear axle 202b. This may allow continuous AWD operation with limited mechanical disruption, particularly in applications where variable torque split is preferred due to surface irregularities or load shift.

In further embodiments, drivetrain 200 includes an electronic traction management system configured to selectively modulate electric motor torque based on vehicle conditions. The electronic traction management system can process sensor inputs including wheel speed differentials, incline angle, axle torque demand, or terrain classification data to determine when rear axle 202b should be engaged.

In all such embodiments, the engagement method is selected based on the current axle connection status (e.g., whether rear axle 202b is presently decoupled), drivetrain constraints (e.g., torque transmission capacity of shaft 310), and detected real-time load or surface data (e.g., slippage, elevation change, or high drawbar force). The system evaluates these variables in real-time to ensure smooth engagement, minimize driveline shock, and reduce energy losses or premature component wear.

At step 710, control signal generator 626 transmits a control signal to clutch 306 to initiate engagement of rear axle 202b. In response to receiving the control signal, clutch 306 transitions from a disengaged state to an engaged state, thereby mechanically coupling rear axle 202b to drivetrain 200. In this configuration, mechanical torque generated by electric motor 204a and delivered through gear transfer box 304 is routed not only to front axle 202a, but also to rear axle 202b via shaft 310.

Upon clutch engagement, forklift 10 transitions from a rear-wheel drive configuration to an all-wheel drive (AWD) configuration. The transition may occur seamlessly, with continuous delivery of torque to front axle 202a and a synchronized ramp-up of torque to rear axle 202b to avoid driveline shock. The AWD engagement may be implemented with controlled slip (e.g., via clutch modulation), which further reduces mechanical stress and provides gradual torque ramping based on traction demand or surface irregularities.

Drivetrain 200 may dynamically adjust torque split or axle load based on real-time sensor data even after AWD is engaged. In some embodiments, clutch 306 remains in a partially engaged state to allow for differential rotation or torque biasing. In other embodiments, once the engagement is complete, drivetrain 200 may reconfigure torque allocation depending on forward speed, incline gradient, or terrain resistance.

In this way, the drivetrain adapts to changing conditions to enhance stability, improve wheel grip, and support load handling, without requiring direct operator input. The automated AWD transition helps maintain consistent vehicle performance during dynamic tasks, such as driving over uneven terrain, ascending slopes, or hauling heavy payloads.

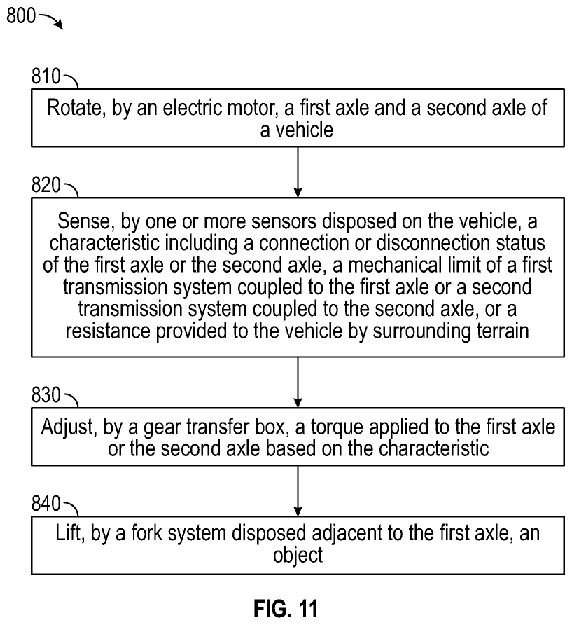

FIG. 11 is a flow diagram of a method 800 of operating a vehicle, according to some embodiments. The method 800 includes a first step 810 of rotating, by an electric motor, a first axle and a second axle of a vehicle. For example, an electric motor can rotate a first axle and a second axle having wheels or other tractive elements disposed thereon to provide a vehicle with four-wheel drive capabilities. The method 800 further includes a second step 820 of sensing, by one or more sensors disposed on the vehicle, a characteristic. The characteristic can include a connection or disconnection status of the first axle or the second axle, a mechanical limit of a first transmission system coupled to the first axle or a second transmission system coupled to the second axle, or a resistance provided to the vehicle by surrounding terrain. For example, a radar sensor or LiDAR sensor disposed on an exterior surface of the vehicle can sense that a steep incline is in a travel path of the vehicle.

The method 800 further includes a third step 830 of adjusting, by a gear transfer box, a torque applied to the first axle or the second axle based on the characteristic. For example, the gear transfer box can increase a torque of the first axle and the second axle in response to sensing that a steep incline is in a travel path of the vehicle to scale the incline. The method 800 further includes a fourth step 840 of lifting, by a fork system disposed adjacent to the first axle, and object. For example, a fork system positioned at the front of the vehicle can lift a heavy box from a ground onto a shelf.

### Configuration of Exemplary Embodiments

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the elements of the systems and methods as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A forklift, comprising:
a chassis including a first axle positioned on a first side of the chassis, and a second axle positioned on a second side of the chassis and extending along a longitudinal axis;
a fork assembly coupled to the first side of the chassis;
a first transmission system coupled to and configured to rotate the first axle;
a second transmission system coupled to and configured to rotate the second axle; and
a gear transfer box coupled to the second axle, wherein the gear transfer box includes a torque amplification stage configured to increase a torque of the first axle,
wherein the second axle is configured to turn about an axial axis perpendicular to the longitudinal axis to steer the forklift.

2. The forklift of claim 1, wherein the first transmission system includes a torque transfer shaft extending between a clutch and the second axle, wherein the torque transfer shaft is configured to amplify torque output from an electric motor.

3. The forklift of claim 2, wherein the clutch couples the gear transfer box to the torque transfer shaft, wherein the clutch is configured to selectively engage and disengage the torque transfer shaft.

4. The forklift of claim 1, further comprising a plurality of tractive elements, each tractive element of the plurality of tractive elements coupled to the first axle or the second axle.

5. The forklift of claim 3, wherein the gear transfer box further includes a differential configured to balance a relative speed between the first axle and the second axle.

6. The forklift of claim 1, further comprising a control system having at least one processor or memory configured to detect terrain conditions and adjust power transmission from the gear transfer box to the first axle or the second axle based on the terrain conditions.

7. The forklift of claim 2, wherein the second transmission system includes a second clutch coupling the gear transfer box to a second torque transfer shaft, wherein the second torque transfer shaft is coupled to the first axle.

8. The forklift of claim 7, wherein the second transmission system further includes the second torque transfer shaft is configured to amplify torque output from the electric motor and the second clutch is configured to selectively engage and disengage the second torque transfer shaft.

9. A forklift, comprising:
a chassis;
a first axle positioned on a first side of the chassis;
a second axle positioned on a second side of the chassis;
a fork assembly on the first side of the chassis;
a first transmission system coupled to and configured to rotate the first axle;
a second transmission system coupled to and configured to rotate the second axle;
a gear transfer box coupled to the second axle, wherein the gear transfer box includes a torque amplification stage configured to increase a torque of the first axle; and
a controller including at least one processor or memory configured to electronically communicate with the gear transfer box to raise or lower a torque of the first axle or the second axle based on one or more vehicle parameters.

10. The forklift of claim 9, wherein the one or more vehicle parameters include:
a connection status of the first axle or the second axle;
a maximum torque of the first transmission system or the second transmission system;
a load on the forklift; or
a terrain surrounding the forklift.

11. The forklift of claim 10, wherein the controller is coupled to one or more tractive element speed sensors, inclination sensors, motor torque sensors, geolocation sensors, or environmental sensors to detect the one or more vehicle parameters.

12. The forklift of claim 11, wherein the environmental sensors include radar or LiDAR sensors.

13. The forklift of claim 9, wherein the first transmission system includes a torque transfer shaft extending between a clutch and the second axle, wherein the torque transfer shaft is configured to amplify torque output from an electric motor.

14. The forklift of claim 13, wherein the clutch couples the gear transfer box to the torque transfer shaft, wherein the clutch is configured to selectively engage and disengage the torque transfer shaft.

15. The forklift of claim 14, wherein the gear transfer box further includes a differential configured to balance a relative speed between the first axle and the second axle.

16. The forklift of claim 14, wherein the second transmission system includes a second clutch coupling the gear transfer box to a second torque transfer shaft, wherein the second torque transfer shaft is coupled to the first axle.

17. The forklift of claim 16, wherein the second torque transfer shaft is configured to amplify torque output from the electric motor and the second clutch is configured to selectively engage and disengage the second torque transfer shaft.

18. A method, comprising:
rotating, by an electric motor, a first axle and a second axle of a vehicle;
sensing, by one or more sensors disposed on the vehicle, a characteristic including:
a connection or disconnection status of the first axle or the second axle;
a mechanical limit of a first transmission system coupled to the first axle or a second transmission system coupled to the second axle; or
a resistance provided to the vehicle by surrounding terrain;
adjusting, by a gear transfer box, a torque applied to the first axle or the second axle based on the characteristic; and
lifting, by a fork system disposed adjacent to the first axle, an object.

19. The method of claim 18, further comprising monitoring, by at least one sensor of the one or more sensors, deformation of a tractive element coupled to the first axle or the second axle or a component of the first transmission system or the second transmission system.

20. The method of claim 18, wherein the first transmission system and the second transmission system each include a clutch coupling the gear transfer box to a torque transfer shaft, wherein the torque transfer shaft is coupled to the first axle or the second axle.
